(19) United States
(12) Patent Application Publication
(10) Pub. No.: US 2016/0315350 A1
(43) Pub. Date: Oct. 27, 2016

(54) LITHIUM-SULPHUR CELL

(71) Applicant: Oxis Energy Limited, Abingdon Oxfordshire (GB)

(72) Inventor: Sebastien Desilani, Abingdon Oxfordshire (GB)

(21) Appl. No.: 15/102,106

(22) PCT Filed: Dec. 16, 2014
(86) PCT No.: PCT/GB2014/053719

§ 371 Date: Jun. 6, 2016

(30) Foreign Application Priority Data
Dec. 17, 2013 (EP) 13197674.8

(51) Int. Cl. H01M 10/0567; H01M 4/38; H01M 2/16; H01M 4/40; H01M 10/0525; H01M 10/0568; H01M 10/0569; H01M 4/136; H01M 4/62

(52) U.S. Cl. CPC H01M 10/0567; H01M 4/136; H01M 4/382; H01M 2/162; H01M 4/38; H01M 4/625; H01M 10/0525; H01M 10/0568; H01M 10/0569; H01M 4/405; H01M 2004/027

(57) ABSTRACT

A lithium-sulphur cell comprising an anode comprising lithium metal or lithium metal alloy, a cathode comprising a mixture of electroactive sulphur material and solid electroconductive material, an electrolyte comprising a tetrafluoroborate salt and an organic solvent, wherein the tetrafluoroborate salt is present in the electrolyte at a concentration of 0.05 to 0.5M, and wherein the tetrafluoroborate salt is present in an amount, wherein the molar ratio of tetrafluoroborate anion, BF4, to sulphur, S, in the electroactive material is 0.009-0.09:1.

The present invention relates to a lithium-sulphur cell. The present invention also relates to the use of a tetrafluoroborate salt as an additive for enhancing the cycle life of a lithium-sulphur battery. In addition, the present invention relates to an electrolyte for a lithium sulphur cell.

### BACKGROUND

A typical lithium-sulphur cell comprises an anode (negative electrode) formed from lithium metal or a lithium metal alloy, and a cathode (positive electrode) formed from elemental sulphur or other electroactive sulphur material. The sulphur or other electroactive sulphur-containing material may be mixed with an electrically conductive material, such as carbon, to improve its electrical conductivity. Typically, the carbon and sulphur are ground and then mixed with a solvent and binder to form a slurry. The slurry is applied to a current collector and then dried to remove the solvent. The resulting structure is calendared to form a composite structure, which is cut into the desired shape to form a cathode. A separator is placed on the cathode and a lithium anode placed on the separator. Electrolyte is introduced into the cell to wet the cathode and separator.

Lithium-sulphur cells are secondary cells, and may be recharged by applying an external current to the cell. Rechargeable cells of this type have a wide range of potential applications. One important consideration when developing lithium-sulphur secondary cells is maximising the useful cycle life of the cell.

When a lithium-sulphur cell is discharged, the sulphur in the cathode is reduced in two-stages. In the first stage, the sulphur (e.g. elemental sulphur) is reduced to polysulphide species, Sₙ²⁻ (n≧2). In the second stage of discharge, the polysulphide species are reduced to lithium sulphide, Li₂S, which, typically, deposits on the surface of the anode. When the cell is charged, the two-stage mechanism typically occurs in reverse, with the lithium sulphide being oxidised to lithium polysulphide and thereafter to lithium and sulphur. It is desirable for the polysulphide species to be soluble in the electrolyte as this increases the utilisation of the electroactive material during discharge. Without the polysulphides dissolution, the reduction of electroactive sulphur may be constrained to the carbon-sulphur interface, resulting in relatively low cell capacities.

The electrolyte of a lithium sulphur cell typically comprises an electrolyte salt and an organic solvent. Suitable electrolyte salts include lithium salts. Examples include lithium hexafluorophosphate (LiPF₆), lithium hexafluoroarsenate (LiAsF₆), lithium perchlorate (LiClO₄), lithium trifluoromethanesulfonimide (LiN(CF₃SO₂)₂) and lithium trifluoromethanesulphonate (CF₃SO₃Li). Such lithium salts provide charge carrying species in the electrolyte, allowing the redox reactions at the electrodes to occur.

Lithium tetrafluoroborate (LiBF₄) is a lithium salt that has be used as an electrolyte salt in lithium-ion cells. However, according to Journal of Power Sources 231 (2013) 153-162, lithium tetrafluoroborate is unsuitable as an electrolyte salt because it reacts with lithium polysulphides as follows:

LiBF₄+Li₂Sₙ→LiBS₂F₂+2LiF

This makes lithium tetrafluoroborate incompatible with polysulphide species (see Section 3.2.2).

### DESCRIPTION

Before particular examples of the present invention are described, it is to be understood that the present disclosure is not limited to the particular cell, method or material disclosed herein. It is also to be understood that the terminology used herein is used for describing particular examples only and is not intended to be limiting, as the scope of protection will be defined by the claims and equivalents thereof.

In describing and claiming the cell and method of the present invention, the following terminology will be used: the singular forms “a”, “an”, and “the” include plural forms unless the context clearly dictates otherwise. Thus, for example, reference to “an anode” includes reference to one or more of such elements.

According to one aspect of the present invention, there is provided a lithium-sulphur cell comprising
an anode comprising lithium metal or lithium metal alloy,
a cathode comprising a mixture of electroactive sulphur material and solid electroconductive material,
an electrolyte comprising a tetrafluoroborate salt and an organic solvent,
wherein the tetrafluoroborate salt is present in the electrolyte at a concentration of 0.05 to 0.5M, and
wherein the tetrafluoroborate salt is present in an amount, wherein the molar ratio of tetrafluoroborate anion, BF₄⁻, to sulphur, S, in the electroactive material is 0.009-0.09:1.

According to another aspect, the present invention also provides the use of a tetrafluoroborate salt as an additive for enhancing the cycle life of a lithium sulphur battery.

Advantageously, it has been found that a tetrafluoroborate salt can be used as an additive to enhance the cycle life of a lithium sulphur battery. Without wishing to be bound by any theory, the tetrafluoroborate anions are believed to solvate the polysulphides formed upon discharge, enhancing their solubility in the electrolyte. This increases the utilisation of the electroactive material during discharge. Without the polysulphides dissolution, the reduction of electroactive sulphur may only occur at the carbon-sulphur interface, resulting in relatively low cell capacities.

As sulphur is non-conducting, the reduction of sulphur is typically restricted to the surface of sulphur particles that are in contact with the electroconductive material or current collector. Smaller sulphur particles are therefore desirable as sulphur in the middle of the particles may not be as readily available for reduction. Surprisingly, the tetrafluoroborate anions are believed to hinder the agglomeration of sulphur. By adding a tetrafluoroborate salt to the cell, the agglomeration of sulphur may be reduced, thereby reducing the resistance of the cell and the tendency for capacity fade. As a result, the cycle life of the cell may be increased.

Any suitable tetrafluoroborate salt may be used. Suitable salts include metal salts and/or ammonium salts. Suitable metal salts include alkali metal salts including salts of potassium, sodium and lithium. Preferably, lithium tetrafluoroborate is employed. Suitable ammonium salts include tetra alkyl ammonium salts. Examples include tetraethyl ammonium salts and tetramethyl ammonium salts.

The tetrafluoroborate salt may be present in the electrolyte at a concentration of 0.05 to 0.5M. The tetrafluoroborate salt concentration should preferably be sufficient to provide an appreciable improvement in cycle life. However, it should preferably not be too high as to give rise to undesirable side reactions. Without wishing to be bound by any theory, it is believed that, at concentrations significantly above 0.5M, the tetrafluoroborate may react with polysulphide species in undesirable side reactions. An example of such an undesirable side reaction is as follows:

LiBF₄+Li₂Sₙ→LiBS₂F₂+2LiF

Preferably, the tetrafluoroborate salt is present in the electrolyte at a concentration of 0.1 to 0.4M, more preferably, 0.2 to 0.3 M, for example, about 0.3 M.

When used in a lithium sulphur cell, the tetrafluoroborate salt is present in an amount, wherein the molar ratio of tetrafluoroborate anion, BF₄⁻, to sulphur, S, in the electroactive material is 0.009-0.09:1, preferably, 0.01-0.09:1, more preferably, 0.02 0.09:1. Preferably, the molar ratio of tetrafluoroborate anion, BF₄⁻, to sulphur, S, in the electroactive material is 0.03-0.08:1, more preferably, 0.04-0.07:1, for example, 0.05-0.07:1. In one embodiment, the molar ratio of tetrafluoroborate anion, BF₄⁻, to sulphur, S, in the electroactive material is 0.06:1. For avoidance of doubt, the molar ratio is calculated on the basis of the number of moles of BF₄⁻ anion in the electrolyte and the number of moles of sulphur (S) in the electroactive material. Accordingly, where the electroactive material does not consist solely of sulphur, the number of moles of sulphur (S) in the electroactive material will be less than the number of moles of electroactive material.

The electrolyte may comprise a further electrolyte salt (i.e. one that is provided in addition to the tetrafluoroborate salt). The further electrolyte salt is preferably a lithium salt, (i.e. a lithium salt that is not lithium tetrafluoroborate). Suitable lithium salts include lithium hexafluorophosphate, lithium hexafluoroarsenate, lithium perchlorate, lithium trifluoromethanesulfonimide and lithium trifluoromethanesulphonate. Preferably the lithium salt is lithium trifluoromethanesulphonate. Combinations of salts may be employed. The further electrolyte salt may be present in the electrolyte at a concentration of 0.1 to 5M, preferably, 0.5 to 3M, for example, 1M. In one embodiment, the further electrolyte salt is a lithium salt that is present in the electrolyte at a concentration that is 50% to 100% of the saturation concentration of the lithium salt in the electrolyte or electrolyte solvent. The lithium salt may be present at a concentration that is 70% to 100% of the saturation concentration, more preferably 80% to 100% of the saturation concentration, for example, 90% to 100% of the saturation concentration. By using such highly concentrated solutions of the further electrolyte that are equal to or close to their saturation limit, the cycling efficiency of the cell may be increased and the rate of capacity fade, reduced.

The molar concentration of tetrafluoroborate salt may be less than 90%, preferably, less than 80%, more preferably less than 70%, yet more preferably less than 60%, for example, less than 50% of the molar concentration of the further electrolyte salt. In one embodiment, the molar concentration of tetrafluoroborate salt may be less than 40%, for example, less than 30% of the molar concentration of the further electrolyte salt. The molar concentration of the tetrafluoroborate salt may be more than 1%, preferably, more than 5%, for example, more than 10% of the molar concentration of the further electrolyte salt. In one embodiment, the molar concentration of tetrafluoroborate salt may be 1 to 40%, preferably, 5 to 30%, for instance, 10 to 20% of the molar concentration of the further electrolyte salt.

In yet another aspect, the present invention provides an electrolyte for a lithium sulphur cell, said electrolyte comprising
a tetrafluoroborate salt,
an organic solvent, and
a lithium salt selected from at least one of lithium hexafluorophosphate, lithium hexafluoroarsenate, lithium perchlorate, lithium trifluoromethanesulfonimide and lithium trifluoromethanesulphonate,
wherein the tetrafluoroborate salt is present in the electrolyte at a concentration of 0.05 to 0.5M, and
wherein the lithium salt is present in the electrolyte at a concentration that is 50% to 100% of the saturation concentration of the lithium salt in the electrolyte.

As discussed above, according to one aspect of the invention there is provided a lithium-sulphur electrochemical cell comprising: an anode comprising lithium metal or lithium metal alloy; a cathode comprising a mixture of electroactive sulphur material and solid electroconductive material; a porous separator; and an electrolyte comprising at least one lithium salt, at least one organic solvent and a surfactant.

The electrochemical cell of the present invention may be any suitable lithium-sulphur cell. The cell typically includes an anode, a cathode, an electrolyte and, preferably, a porous separator, which may advantageously be positioned between the anode and the cathode. The anode may be formed of lithium metal or a lithium metal alloy. Preferably, the anode is a metal foil electrode, such as a lithium foil electrode. The lithium foil may be formed of lithium metal or lithium metal alloy.

The cathode of the electrochemical cell includes a mixture of electroactive sulphur material and electroconductive material. This mixture forms an electroactive layer, which may be placed in contact with a current collector.

The electroactive sulphur material may comprise elemental sulphur, sulphur-based organic compounds, sulphur-based inorganic compounds and sulphur-containing polymers. Preferably, elemental sulphur is used.

The solid electroconductive material may be any suitable conductive material. Preferably, this solid electroconductive material may be formed of carbon. Examples include carbon black, carbon fibre, graphene and carbon nanotubes. Other suitable materials include metal (e.g. flakes, filings and powders) and conductive polymers. Preferably, carbon black is employed.

The mixture of electroactive sulphur material and electroconductive material may be applied to the current collector in the form of a slurry in a solvent (e.g. water or an organic solvent). The solvent may then be removed and the resulting structure calendared to form a composite structure, which may be cut into the desired shape to form a cathode. A separator may be placed on the cathode and a lithium anode placed on the separator. Electrolyte may then be introduced into the assembled cell to wet the cathode and separator. Alternatively, the electrolyte may be applied to the separator, for example, by coating or spraying before the lithium anode is placed on the separator.

As discussed above, the cell comprises an electrolyte. The electrolyte is present or disposed between the electrodes, allowing charge to be transferred between the anode and cathode. Preferably, the electrolyte wets the pores of the cathode as well as the pores of the separator.

Suitable organic solvents for use in the electrolyte are tetrahydrofurane, 2-methyltetrahydrofurane, dimethylcarbonate, diethylcarbonate, ethylmethylcarbonate, methylpropylcarbonate, methylpropylpropionate, ethyl propylpropionate, methyl acetate, dimethoxyethane, 1,3-dioxolane, diglyme (2-methoxyethyl ether), tetraglyme, ethylene carbonate, propylene carbonate, butyrolactone, dioxolane, hexamethyl phosphoamide, pyridine, dimethyl sulfoxide, tributyl phosphate, trimethyl phosphate, N, N, N, N-tetraethyl sulfamide, and sulfone and their mixtures. Preferably, the organic solvent is a sulfone or a mixture of sulfones. Examples of sulfones are dimethyl sulfone and sulfolane. Sulfolane may be employed as the sole solvent or in combination, for example, with other sulfones. In one embodiment, the electrolyte comprises lithium trifluoromethanesulphonate and sulfolane.

The organic solvent used in the electrolyte should be capable of dissolving the polysulphide species, for example, of the formula Sₙ²⁻, where n=2 to 12, that are formed when the electroactive sulphur material is reduced during discharge of the cell. As discussed above, the tetrafluoroborate anion advantageously solvates the polysulphides, increasing their solubility in the electrolyte.

Where a separator is present in the cell of the present invention, the separator may comprise any suitable porous substrate that allows ions to move between the electrodes of the cell. The separator should be positioned between the electrodes to prevent direct contact between the electrodes. The porosity of the substrate should be at least 30%, preferably at least 50%, for example, above 60%. Suitable separators include a mesh formed of a polymeric material. Suitable polymers include polypropylene, nylon and polyethylene. Non-woven polypropylene is particularly preferred. It is possible for a multi-layered separator to be employed.

### EXAMPLES

### Example 1

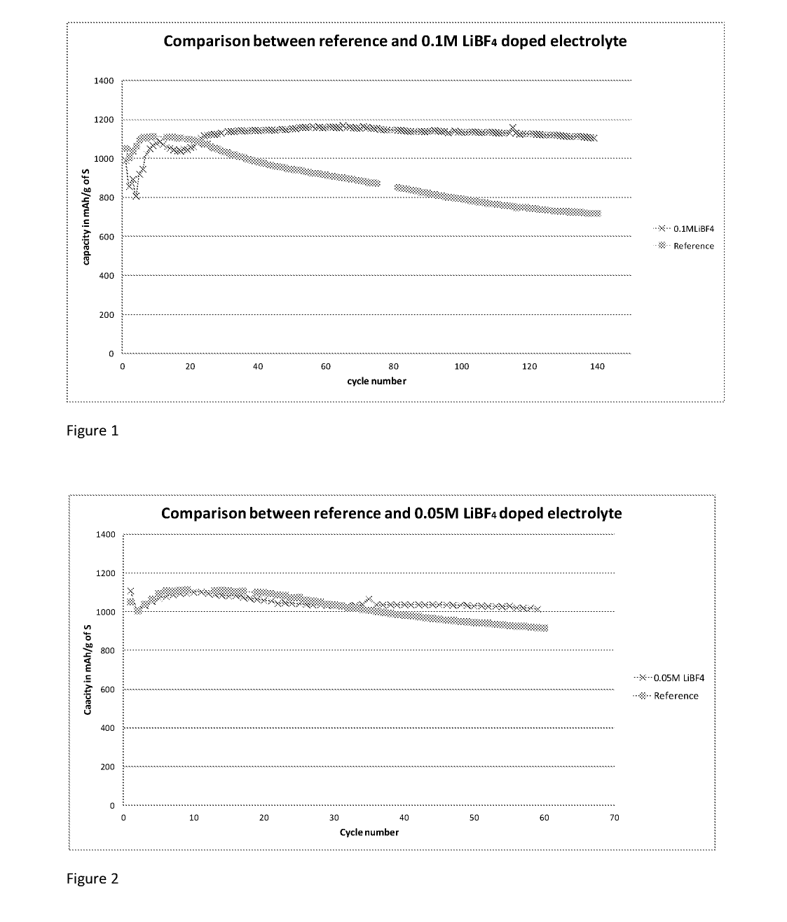

In this Example, an electrolyte comprising 1M lithium triflate in sulfolane was used as a reference electrolyte in a lithium-sulphur cell. The discharge capacity of this reference cell was determined over approximately 140 cycles. A further cell was produced in the same manner except that lithium tetrafluoroborate was added to the reference electrolyte to form a 0.1 M LiBF₄ solution in the electrolyte. The discharge capacities of the cells were determined over approximately 140 cycles. As can be seen from FIG. 1, the rate of capacity fade is reduced by the addition of the tetrafluoroborate salt. In this Example, the ratio of tetrafluoroborate anion, BF₄⁻, to S in the electroactive material was 0.01875:1.

### Example 2

In this Example, a further cell was produced in the same manner as the reference cell of Example 1 except that lithium tetrafluoroborate was added to the reference electrolyte to form a 0.05M LiBF₄ solution in the electrolyte. The discharge capacity of the cell was determined over approximately 60 cycles. These discharge capacities were compared with the discharge capacity of the reference cell. As can be seen from FIG. 2, with the addition of the tetrafluoroborate salt, an improvement in capacity fade can be observed after approximately 35 cycles. In this Example, the ratio of tetrafluoroborate anion, BF₄⁻, to S in the electroactive material was 0.0093:1.

### Example 3

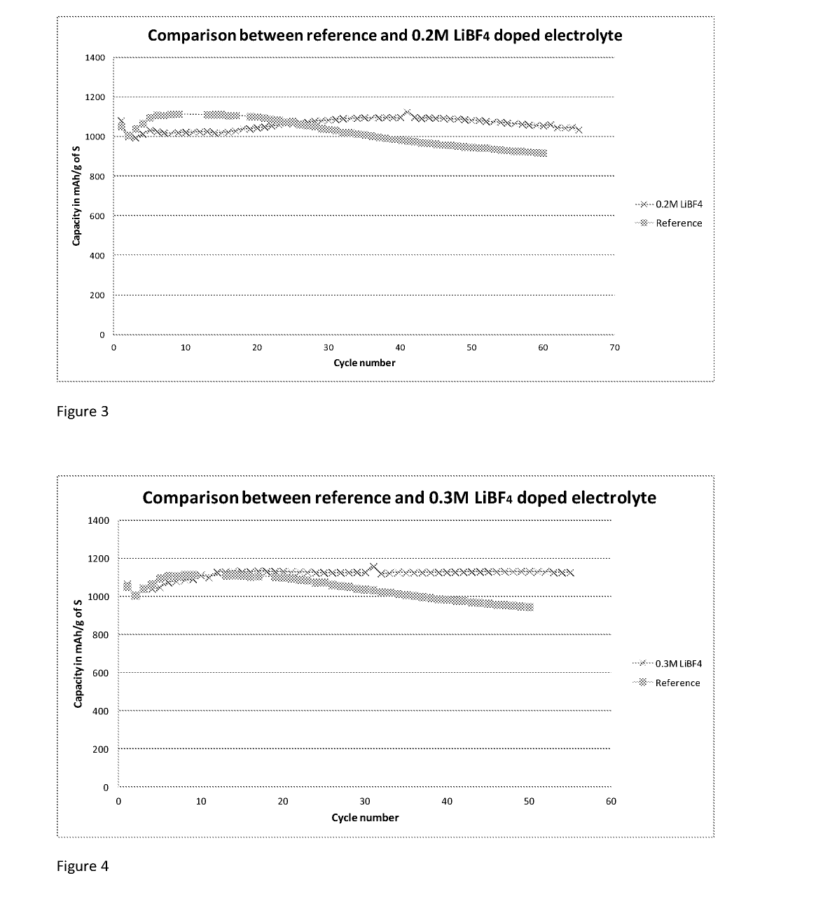

In this Example, a further cell was produced in the same manner as the reference cell of Example 1 except that lithium tetrafluoroborate was added to the reference electrolyte to form a 0.2M LiBF₄ solution in the electrolyte. The discharge capacity of the cell was determined over 60+ cycles. These discharge capacities were compared with the discharge capacity of the reference cell. As can be seen from FIG. 3, with the addition of the tetrafluoroborate salt, an improvement in capacity fade can be observed after approximately 25 cycles. In this Example, the ratio of tetrafluoroborate anion, BF₄⁻, to S in the electroactive material was 0.0375:1.

### Example 4

In this Example, a further cell was produced in the same manner as the reference cell of Example 1 except that lithium tetrafluoroborate was added to the reference electrolyte to form a 0.3M LiBF₄ solution in the electrolyte. The discharge capacity of the cell was determined over 50+ cycles. These discharge capacities were compared with the discharge capacity of the reference cell. As can be seen from FIG. 4, with the addition of the tetrafluoroborate salt, an improvement in capacity fade is observed. In this Example, the ratio of tetrafluoroborate anion, BF₄⁻, to S in the electroactive material was 0.05625:1.

### Example 5

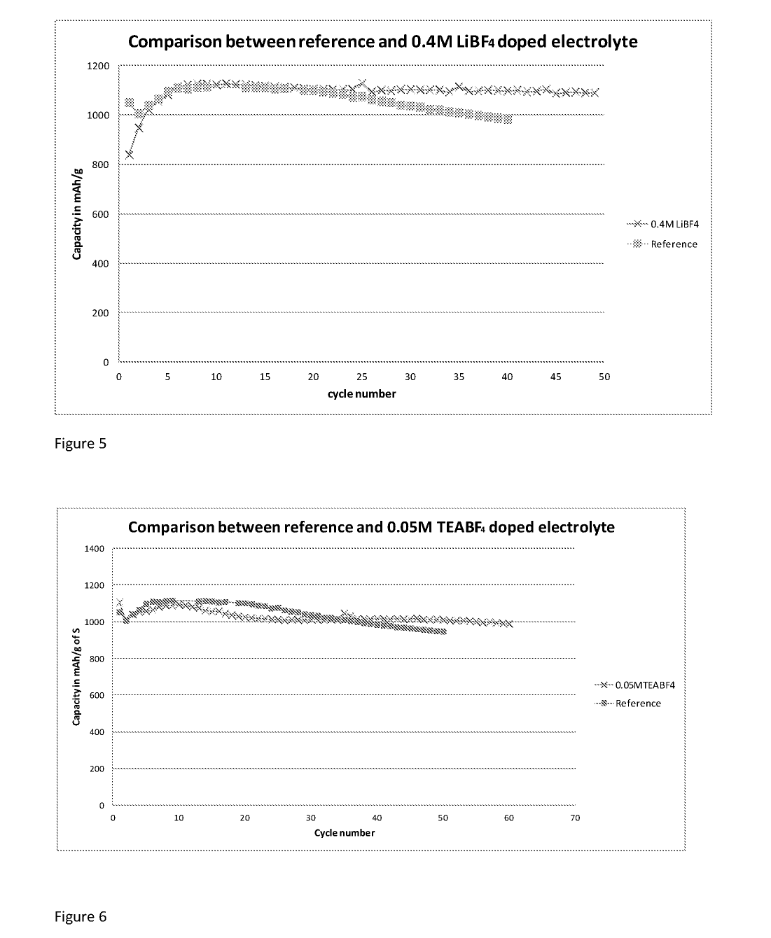

In this Example, a further cell was produced in the same manner as the reference cell of Example 1 except that lithium tetrafluoroborate was added to the reference electrolyte to form a 0.4M LiBF₄ solution in the electrolyte. The discharge capacity of the cell was determined over 40+ cycles. These discharge capacities were compared with the discharge capacity of the reference cell. As can be seen from FIG. 5, with the addition of the tetrafluoroborate salt, an improvement in capacity fade is observed. In this Example, the ratio of tetrafluoroborate anion, BF₄⁻, to S in the electroactive material was 0.075:1.

### Example 6

In this Example, a further cell was produced in the same manner as the reference cell of Example 1 except that tetraethyl ammonium tetrafluoroborate was added to the reference electrolyte to form a 0.05M TEABF₄ solution in the electrolyte. The discharge capacity of the cell was determined over 50+ cycles. These discharge capacities were compared with the discharge capacity of the reference cell. As can be seen from FIG. 6, with the addition of the tetrafluoroborate salt, an improvement in capacity fade is observed. In this Example, the ratio of tetrafluoroborate anion, BF₄⁻, to Sin the electroactive material was 0.0093:1.

### Example 7

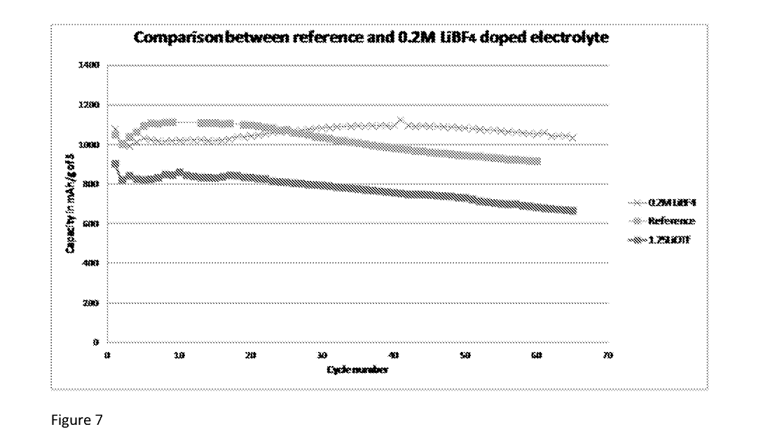

In this Example, a further cell was produced in the same manner as the reference cell of Example 1 except that an electrolyte comprising 1.25M lithium triflate in sulfolane was used. The discharge capacity of the cell was determined over 50+ cycles. These discharge capacities were compared with the discharge capacity of the reference cell and the cell of Example 3 (1M lithium triflate+0.2M LiBF₄). As can be seen from FIG. 7, the cell formed using an electrolyte comprising 1.25M lithium triflate performed significantly worse than a cell formed using an electrolyte comprising 1M lithium triflate+0.2M LiBF₄ despite the overall lithium salt concentrations in the electrolyte being comparable. The addition of 0.2M LiBF₄ to the electrolyte significantly improved the cell's resistance to capacity fade.

1. A lithium-sulphur cell comprising:
an anode comprising lithium metal or lithium metal alloy,
a cathode comprising a mixture of electroactive sulphur material and solid electroconductive material,
an electrolyte comprising a tetrafluoroborate salt and an organic solvent,
wherein the tetrafluoroborate salt is present in the electrolyte at a concentration of 0.05 to 0.5M, and
wherein the tetrafluoroborate salt is present in an amount, wherein the molar ratio of tetrafluoroborate anion, BF₄⁻, to sulphur, S, in the electroactive material is 0.009-0.09:1.

2. The cell of claim 1, wherein the tetrafluoroborate salt is present in the electrolyte at a concentration of 0.1 to 0.4M.

3. The cell of claim 1, wherein the tetrafluoroborate salt is present in an amount wherein the molar ratio of tetrafluoroborate anion, BF₄⁻, to sulphur, S, in the electroactive material is 0.04-0.07:1.

4. The cell of claim 1, wherein the tetrafluoroborate salt is an alkali metal or ammonium salt.

5. The cell of claim 4, wherein the tetrafluoroborate salt is lithium tetrafluoroborate and/or tetraethyl ammonium tetrafluoroborate.

6. The cell of claim 1, wherein the electrolyte comprises a further electrolyte salt.

7. The cell of claim 6, wherein the further electrolyte salt is a lithium salt.

8. The cell of claim 7, wherein the lithium salt is selected from at least one salt selected from lithium hexafluorophosphate, lithium hexafluoroarsenate, lithium perchlorate, lithium trifluoromethanesulfonimide and lithium trifluoromethanesulphonate.

9. The cell of claim 6, wherein the further electrolyte salt is present in the electrolyte at a concentration of 0.3 to 2M.

10. The cell of claim 7, wherein the further electrolytelithium salt is present in the electrolyte at a concentration that is 50% to 100% of the saturation concentration of the lithium salt in the electrolyte.

11. The cell of claim 7, wherein the molar concentration of tetrafluoroborate salt is 10 to 20% of the molar concentration of the further electrolyte salt.

12. The cell of claim 1, wherein the electroactive sulphur material is elemental sulphur.

13. Use of a tetrafluoroborate salt as an additive for enhancing the cycle life of a lithium sulphur battery.

14. An electrolyte for a lithium sulphur cell, said electrolyte comprising:
a tetrafluoroborate salt,
an organic solvent, and
a lithium salt selected from at least one of lithium hexafluorophosphate, lithium hexafluoroarsenate, lithium perchlorate, lithium trifluoromethanesulfonimide and lithium trifluoromethanesulphonate,
wherein the tetrafluoroborate salt is present in the electrolyte at a concentration of 0.05 to 0.5M, and
wherein the further electrolyte salt is present in the electrolyte at a concentration that is 50% to 100% of the saturation concentration of the lithium salt in the electrolyte.
